(19) United States
(12) Patent Application Publication
(10) Pub. No.: US 2012/0024955 A1
(43) Pub. Date: Feb. 2, 2012

(54) ELECTRONIC SLIDE-IN MODULES THAT SLIDE INTO A MODULE CARRIER, MODULE CARRIERS, AS WELL AS ARRANGEMENTS WITH A SLIDE-IN MODULE

(75) Inventor: Gerhard Mühsam, Königsbrunn (DE)

(73) Assignee: Fujitsu Technology Solutions Intellectual Property GmbH, München (DE)

(21) Appl. No.: 13/190,557

(22) Filed: Jul. 26, 2011

(30) Foreign Application Priority Data
Jul. 27, 2010 (DE) 10 2010 032 366.7

(51) Int. Cl. G06K 7/10; G06K 7/01; G06F 1/16

(52) U.S. Cl. 235/462.01; 361/679.31; 235/439

(57) ABSTRACT

An electronic slide-in module that slides into a module carrier includes at least one electronic read-out unit that reads out information from an information storage unit in the module carrier without electrical contact with the module carrier.

### RELATED APPLICATION

This application claims priority of German Patent Application No. 10 2010 032 366.7, filed Jul. 27, 2010, herein incorporated by reference.

### TECHNICAL FIELD

This disclosure relates to an electronic slide-in module for sliding into a module carrier, a module carrier with at least one slide-in location for holding at least one electronic slide-in module, as well as an arrangement with a slide-in module and a module carrier.

### BACKGROUND

Slide-in modules are often held in module carriers, wherein a plurality of slide-in modules can be integrated into a larger data-processing system. Such a situation exists, for example, in data centers in which a plurality of servers as slide-in modules is held in server racks as module carriers. In the case of service, a slide-in module must be located quickly to find and correct a failure or fault behavior of the slide-in module as quickly as possible. But for communication between several slide-in modules, an identification, allocation, and differentiation of individual slide-in modules is also needed. Furthermore, it can be necessary for a slide-in module to receive information on the module carrier to adapt, for example, its operating behavior to the conditions of the module carrier.

Even for a large number of slide-in modules, it is well established to allocate each slide-in module to its corresponding module carrier or even to its slide-in location in the module carrier with an identification code. This identification code can be queried and leads to the module carrier and the slide-in location of the slide-in module.

To generate such an identification code, each slide-in location within the module carrier usually has a read-out unit available for generating a readable marking on a slide-in module or an electrical terminal for the coding of a corresponding slide-in module. Fitting a module carrier with corresponding electronic components and modules is cost-intensive. The module carriers often have, in addition, a bus system, for example, a management bus. The identification code generated for each slide-in module can be forwarded by this bus system to a management unit. Fitting a module carrier with such a bus system is cost-intensive.

Another possibility for the allocation of a slide-in module to its respective slide-in location in the module carrier is the input of corresponding information into a service module (front end) of the module carrier. One disadvantage of that possibility is that information is reprogrammed each time changes are realized in the allocation of a corresponding slide-in module to a slide-in location of the module carrier.

It could therefore be helpful to provide a slide-in module, a module carrier, as well as an arrangement with a slide-in module and a module carrier of the type described above that allow simplified identification and allocation of a slide-in module to a module carrier.

### SUMMARY

I provide an electronic slide-in module that slides into a module carrier including at least one electronic read-out unit that reads out information from an information storage unit in the module carrier without electrical contact with the module carrier.

I also provide a module carrier with at least one slide-in location to hold at least one electronic slide-in module including at least one information storage unit that stores information and interacts with a read-out unit of the slide-in module without electrical contact with the slide-in module.

I further provide an arrangement with a slide-in module including an electronic slide-in module that slides into a module carrier including at least one electronic read-out unit that reads out information from an information storage unit in the module carrier without electrical contact with the module carrier and a module carrier with at least one slide-in location to hold at least one electronic slide-in module including at least one information storage unit that stores information and interacts with a read-out unit of the slide-in module without electrical contact with the slide-in module.

### BRIEF DESCRIPTION OF THE DRAWINGS

FIG. 1 is a perspective diagram of an arrangement of slide-in modules in a module carrier.

FIG. 2 is a schematized section diagram of a first example according to a first section axis from FIG. 1.

FIG. 3 is a schematized section diagram of a detailed example from FIG. 2 according to a second section axis from FIG. 1.

FIG. 4 is a schematized diagram of another example, wherein the slide-in module and module carrier do not interact.

FIG. 5 shows an example according to FIG. 4, wherein the slide-in module and module carrier interact.

### LIST OF REFERENCE SYMBOLS

1 Slide-in module
2 Module carrier
3 Read-out unit
4 Information storage unit
5a to 5d Contact elements
6a to 6d Counter contact elements
7 Electrical line
8 Analog-digital converter
9 Microcontroller
10a to 10d Electrical contacts
A′-A Section line
B′-B Section line

### DETAILED DESCRIPTION

It will be appreciated that the following description is intended to refer to specific examples of structure selected for illustration in the drawings and is not intended to define or limit the disclosure, other than in the appended claims.

I provide an electronic slide-in module that slides into a module carrier, wherein the slide-in module has at least one electronic read-out unit that is designed to read out information from an information storage unit in the module carrier without electrical contact to the module carrier.

In this solution, the slide-in module itself detects information stored in the module carrier. A corresponding read-out unit sits in the slide-in module and not in the module carrier. Data-processing units and respective processes of the slide-in module are used to detect and process information from the module carrier in which the slide-in module is slid-in. The information can be interpreted by the slide-in module itself and/or forwarded to a management unit for the control and management of slide-in modules in the module carrier for service purposes. Forwarding can be carried out via a network, for example, a LAN (local area network). The solution makes complicated wiring of a module carrier unnecessary. A bus system for detection of an identification code of a slide-in module and allocation of the slide-in module to its slide-in location in the module carrier is eliminated. A use of this solution is given, for example, in a server rack in which several servers are slid in, wherein, for maintenance purposes of the servers, their slide-in locations are identified and allocated.

The read-out unit may comprise a barcode reader. The read-out unit may also comprise an RFID reader (RFID=radio frequency identification). A reading of information from the module carrier can be carried out using a non-contact method. “Non-contact” means that the slide-in module and the module carrier have neither electrical nor mechanical contact between the read-out unit of the slide-in module and the information storage unit of the module carrier. This has the advantage that tolerances between the slide-in module and the module carrier have no or only an insignificant influence on the interaction between the read-out unit and information storage unit. This is because direct contact between the components is not needed. Such tolerances are given, in particular, through different constructions of mounting systems in the module carrier or for the use of slide-in modules with different height dimensions.

Furthermore, non-contact operation systems can simply be reprogrammed or recoded so that the read-out unit of the slide-in module can be correspondingly adapted to a change in the configuration in the module carrier. Thus, a reprogramming of the read-out unit is possible, for example, to a different transmission protocol or to a different coding of information. In addition, the read-out unit can be adapted to very different types of information. For example, information on the location number of the slide-in location is expanded by additional information such as available height units in the module carrier, type and identification of the module carrier, manufacturing data or temperature data within the module carrier. The read-out unit can then be reprogrammed accordingly, so that it may read the available information.

The read-out unit may further comprise a plurality of contact elements designed to generate electrical information when they interact with counter contact elements of the information storage unit in the module carrier. Preferably, the contact elements can be moved mechanically for closing electrical contacts within the read-out unit. Electrical information can be generated such that each of the contact elements is shifted mechanically when interacting with counter contact elements in the module carrier. Hence, electrical contacts allocated to the contact elements are held either closed or open by the mechanical movement of the contact elements. Therefore, it is possible to generate or change an electrical current and/or an electrical voltage on each contact within the read-out unit and generate electrical information.

To process information that can be read out from the module carrier, the read-out unit can also have, in addition to an information detection unit, an information processing unit. In this way, for example, an analog-digital conversion of analog electrical signals can be carried out so that digital signals are generated. These digital signals can then be forwarded to a logic unit. The logic unit can further process the signals and/or transmit them to another management unit via a network. It is also conceivable that a corresponding management unit is arranged in a slide-in module itself.

I also provide a module carrier with at least one slide-in location to hold at least one electronic slide-in module, wherein the module carrier has at least one information storage unit designed to store information and interact with a read-out unit of the slide-in module without electrical contact to the slide-in module. The module carrier here comprises only a means for storing or saving information. Detection and evaluation of this information is not carried out by the module carrier, but instead by a slide-in module that is slid into the module carrier. The slide-in module performs identification itself by reading out the corresponding information from the module carrier. Stored information can comprise, for example, the slide-in location number, available height units, type and identification of the module carrier, manufacturing data or temperature data in the module carrier. The module carrier itself is passive. Thus, no device of a bus system is needed for the identification of a slide-in module in the module carrier. The solution allows a simple configuration of slide-in modules and saves costs in the module carrier.

The information storage unit may comprise a barcode strip. The information storage may comprise an RFID transponder. In each instance, the module carrier corresponds to the counter pieces corresponding read-out units in a slide-in module as a barcode reader or RFID reader. Through such a design of the information storage unit, a non-contact detection of the information from the module carrier is possible with a read-out unit of the slide-in module. In this way, the already mentioned advantages are produced. If the information to be read out is to be changed, it is possible, for example, to replace a barcode strip for coding a slide-in location in the module carrier by a new barcode strip or to reprogram the RFID transponder in a slide-in location of the module carrier by a suitable programming device or likewise to replace this transponder.

The information storage unit may also comprise a plurality of recesses that are designed to interact with contact elements of the read-out unit of the slide-in module and have different depths such that information is coded mechanically. Thus, in the interaction with contact elements of the slide-in module, in particular, with contact elements that can be moved mechanically, a pure mechanical coding can be carried out at least on the side of the module carrier. For each slide-in location, recesses of a different number and/or different depth are arranged in a characteristic pattern. The contact elements of the slide-in module thus can be moved differently in a mechanical way, in particular, pressed, and each generates a different electrical contacting within the read-out unit of the slide-in module. The mechanical coding is thus converted into an electrical signal or signal pattern. Each slide-in location can have, in the module carrier, a board with recesses that are provided in different numbers and/or with different depths.

Preferably, the information storage unit is a passive unit without a power supply. No power-supply electronics are needed in the module carrier. The module carrier consumes no power and has a simple construction. This allows further cost reduction.

I further provide an arrangement with a slide-in module and a module carrier of the type named above. The already named and explained advantages are also given.

Turning now to the drawings, my modules and module carriers will be explained in greater detail with reference to several examples.

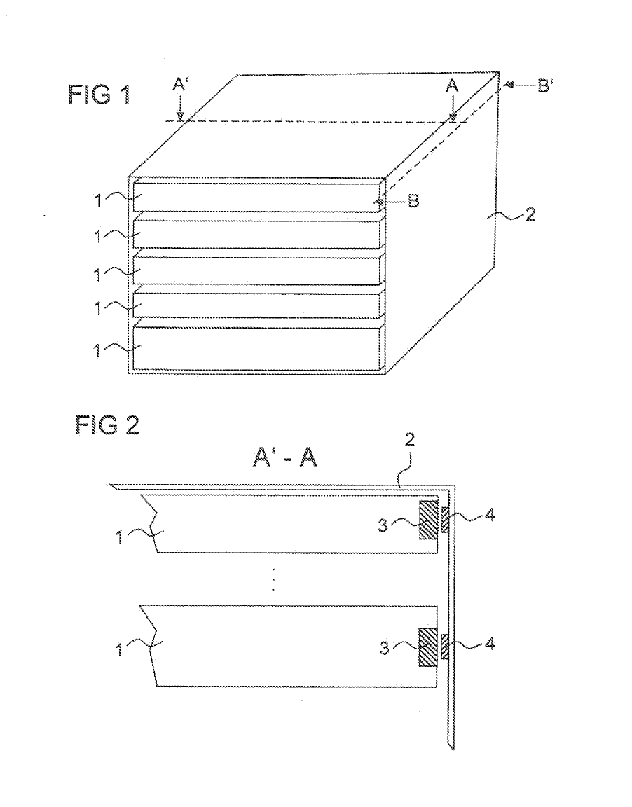

FIG. 1 shows a module carrier 2 in which several slide-in modules 1 are slid in and held. The slide-in modules 1 can represent, for example, servers, in particular, blade servers, and together form a computing system in the module carrier 2. The module carrier 2 is, for example, a server rack for setting up the slide-in modules 1 in a data center.

FIG. 2 shows a schematized section diagram according to the section axis A′-A from FIG. 1. FIG. 2 shows a first example of the slide-in modules 1 and of the module carrier 2. The slide-in modules 1 are held in the module carrier 2 and each have a read-out unit 3. Known means for mounting the slide-in modules 1 in the module carrier 2 are provided and used, but not shown here.

The module carrier 2 has information storage units 4 that are arranged according to this construction at the respective slide-in location of the slide-in modules 1 such that they can interact with the read-out units 3 of the slide-in modules 1. The information storage units 4 provide information that can be read out by the read-out units 3 of the slide-in modules 1. Such information relates, for example, to the identification of the slide-in locations in the module carrier 2, available rack units or height units in the module carrier 2, manufacturing and identification data of the module carrier 2 itself, or temperature data within the module carrier 2.

In the construction according to FIG. 2, the read-out units 3 and the information storage units 4 interact using a non-contact method. This means that the read-out units 3 and information storage units 4 have neither electrical nor mechanical contact. According to the construction in FIG. 2, the read-out units 3 are, for example, barcode readers or RFID readers and the information storage units 4 are barcode strips or RFID transponders. According to one method for the identification of a slide-in module 1 in a module carrier 2, a read-out unit 3 of the slide-in module 1 can interact during or after sliding in the slide-in module 1 with the information storage unit 4 in the module carrier 2, read out information, process this information, and optionally forward the information to a management or service unit.

In the case of a construction of the components 3 and 4 as barcode readers and strips, the detection of information from the information storage units 4 is carried out, for example, by scanning the information storage units 4 with a laser light emitted by the read-out units 3. The laser light is reflected back characteristically in a characteristic pattern of light/dark changes of the barcode strip into the read-out units 3, wherein the detected information can be decoded and processed electrically.

According to the construction of the components 3 and 4 as RFID readers and transponders, reading-out of the information from the information storage units 4 is carried out by the read-out units 3 according to known RFID technology. The read-out units 3 emit, for example, a changing electromagnetic field, by which reception antennas in the information storage units 4 are excited electrically so that a logic unit, in particular, a microchip in the information storage units 4 becomes electrically active and couples electrical information into the emitted changing electromagnetic field and/or influences the reflection of the electromagnetic wave so that the read-out units 3 can decode and further process electrical signals.

The advantage of the non-contact functioning of the components 3 and 4 is that an error-free operation is maintained when the module carrier 2 and/or the slide-in modules 1 become dirty, in particular, through frequent opening of the module carrier 2 for maintenance purposes. Also, a frequent changing and insertion, as well as removal, of slide-in modules 1 in the module carrier 2 and a wearing of elements associated with these actions does not influence functioning of the components 3 and 4. Furthermore, a tolerance between a slide-in module 1 and a slide-in location in the module carrier 2, with this tolerance arising from mounting elements for installation of the slide-in module 1 in the module carrier 2 or from different heights of slide-in modules 1, can be equalized within certain limits by the non-contact operation of the components 3 and 4.

In FIG. 2, two slide-in modules 1 are illustrated as an example, wherein the upper slide-in module 1 has a smaller height than the lower slide-in module 1. An application of an information transfer from the module carrier 2 to the corresponding slide-in modules 1 can include, for example, the two slide-in modules 1 reporting not only an identification of their slide-in locations, but also an identification of available height units in the module carrier 2. In this way, the two slide-in modules 1 can detect, for example, information on how many height units can be built in the module carrier 2. This information can be forwarded to a management unit that is arranged either in one or two of the slide-in modules 1 or separately. The management unit can then detect how much space is still free in the module carrier 2 and how many additional slide-in modules 1 can be slid in at which position in the module carrier 2.

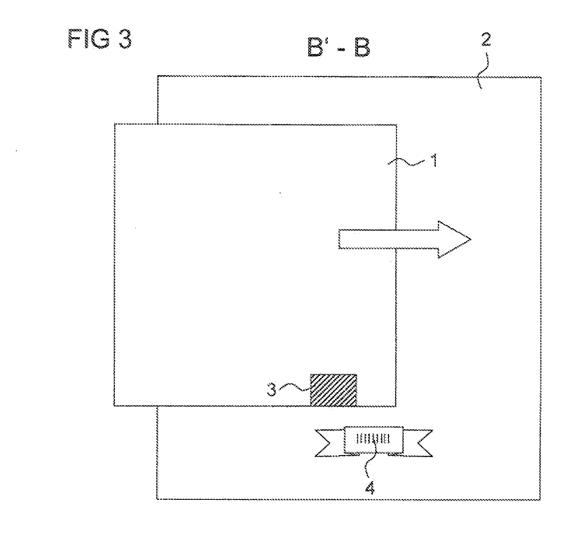

FIG. 3 shows a schematized diagram of a detailed example from FIG. 2 according to the section axis B′-B from FIG. 1. A slide-in module 1 is slid into the module carrier 2 in the direction of the arrow. In the module carrier 2, at the height of the slide-in location of the slide-in module 1 there is an information storage unit 4 that presents, in this construction, a barcode strip. Furthermore, the slide-in module 1 has a read-out unit 3 arranged such that it can interact with the information storage unit 4 in the module carrier 2. In the position of the slide-in module 1 shown in FIG. 3, the read-out unit 3 is not yet completely level and congruent with the information storage unit 4. The slide-in module 1 can be slid in further in the direction of the arrow so that the read-out unit 3 is guided along the information storage unit 4. With the help of a laser beam of the read-out unit 3, the barcode strip of the information storage unit 4 can be read out.

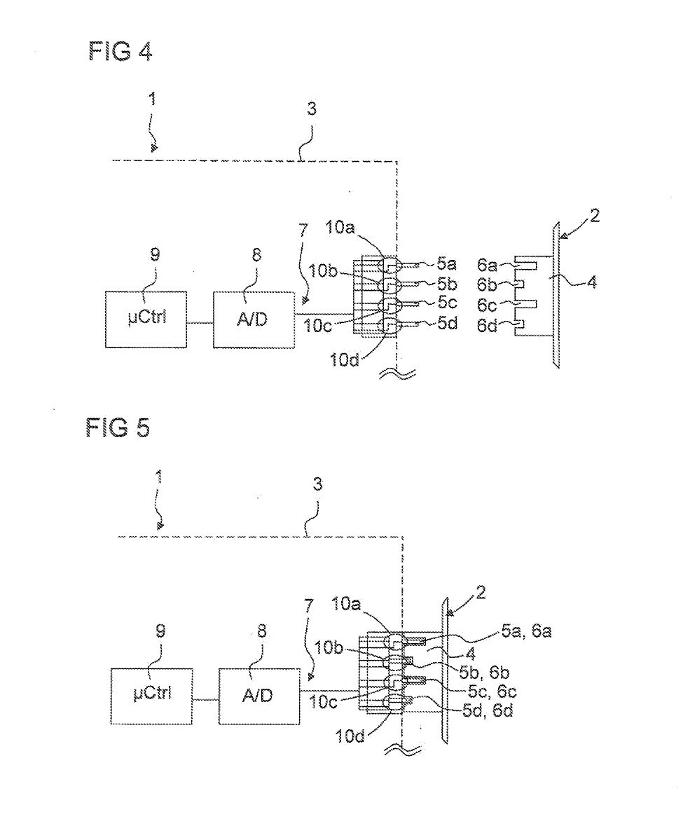

FIG. 4 shows a schematized diagram of another example of a read-out unit 3 of a slide-in module 1 and an information storage unit 4 of a module carrier 2, wherein the slide-in module 1 and the module carrier 2 do not interact. According to the example in FIG. 4, the components 3 and 4 are constructed such that, in contrast to the examples according to FIGS. 2 and 3, a reading-out of information is not carried out in a mechanically non-contact way.

The read-out unit 3 has several contact elements 5a to 5d constructed as contact pins. The contact elements 5a to 5d can be moved mechanically such that they can be pressed into the housing of the read-out unit 3. When pressing in one or more of the contact elements 5a to 5d, a corresponding contact 10a to 10d closes so that an electrical signal is generated or changed on the respective contact 10a to 10d and is forwarded by electrical lines 7 to an analog-digital converter 8. The analog-digital converter 8 converts the analog signals into digital signals and finally transmits these signals to a microcontroller 9 for further processing and/or transmission to a management unit (not shown).

The information storage unit 4 of the module carrier 2 is designed in this example such that counter contact elements 6a to 6d are designed as recesses for interaction with contact elements 5a to 5d. The recesses have different depths. A slide-in location can thus be coded by a different construction and arrangement of different recesses. Additional information of the already explained type can also be coded in this way.

For example, the counter contact elements 6a and 6c according to FIG. 4 have recesses that have a deeper construction than the recesses of the counter contact elements 6b and 6d. The counter contact elements 6a to 6d here interact differently with the contact elements 5a to 5d, which will be explained in detail in FIG. 5.

FIG. 5 shows an example according to FIG. 4 during interaction of the read-out unit 3 of slide-in module 1 with the information storage unit 4 of module carrier 2. Due to the special arrangement of the counter contact elements 6a to 6d with recesses with different dimensions, a part of the contact elements 5a to 5d is pressed mechanically and the other part is not. In particular, the contact elements 5a and 5c are inserted into the deep recesses 6a and 6c and are not moved or only barely moved mechanically. There is a different behavior for the contact elements 5b and 5d that are inserted into the recesses 6b and 6d of lower depth and are pressed by counter contact elements 6b and 6d into the housing of the read-out unit 3. The contacts 10a and 10c are open, the contacts 10b and 10d are closed.

For example, on all of the contacts 10a to 10d, a voltage of the slide-in module 1 is applied, wherein this voltage, in the case of closed contacts 10b and 10d, changes, for example, is reduced to ground potential and, in the case of open contacts 10a and 10c, is maintained as an open-circuit potential. In this way, through mechanical interaction of the contact elements 5a to 5d and the counter contact elements 6a to 6d, an electrical signal pattern is generated in the read-out unit 3 that can be detected by means of the analog-digital converter 8 and can be processed and optionally forwarded in the microcontroller 9. In this way, for example, different slide-in locations of the module carrier 2 can be coded mechanically and decoded electrically.

In not-shown examples, the read-out unit 3 and the information storage unit 4 could also have a combination of non-contact components or electrically contacting components according to the explained examples. This could be adapted according to the requirements on reading out information from the module carrier 2. Also, the individual structures shown and described are merely examples in the selection and construction of all of the components.

1. An electronic slide-in module that slides into a module carrier comprising at least one electronic read-out unit that reads out information from an information storage unit in the module carrier without electrical contact with the module carrier.

2. The electronic slide-in module according to claim 1, wherein the read-out unit comprises a barcode reader.

3. The electronic slide-in module according to claim 1, wherein the read-out unit comprises an RFID reader.

4. The electronic slide-in module according to claim 1, wherein the read-out unit comprises a plurality of contact elements that generate electrical information when they interact with counter contact elements of the information storage unit in the module carrier, and the contact elements are mechanically movable to close electrical contacts within the read-out unit.

5. A module carrier with at least one slide-in location to hold at least one electronic slide-in module comprising at least one information storage unit that stores information and interacts with a read-out unit of the slide-in module without electrical contact with the slide-in module.

6. The module carrier according to claim 5, wherein the information storage unit comprises a barcode strip.

7. The module carrier according to claim 5, wherein the information storage unit comprises an RFID transponder.

8. The module carrier according to claim 5, wherein the information storage unit comprises a plurality of recesses that interact with contact elements of the read-out unit of the slide-in module and have different depths such that information is coded mechanically.

9. The module carrier according to claim 5, wherein the information storage unit is a passive unit without power supply.

10. An arrangement with a slide-in module comprising an electronic slide-in module that slides into a module carrier comprising at least one electronic read-out unit that reads out information from an information storage unit in the module carrier without electrical contact with the module carrier and a module carrier with at least one slide-in location to hold at least one electronic slide-in module comprising at least one information storage unit that stores information and interacts with a read-out unit of the slide-in module without electrical contact with the slide-in module.

11. The electronic slide-in module according to claim 2, wherein the read-out unit comprises an RFID reader.

12. The electronic slide-in module according to claim 2, wherein the read-out unit comprises a plurality of contact elements that generate electrical information when they interact with counter contact elements of the information storage unit in the module carrier, and the contact elements are mechanically movable to close electrical contacts within the read-out unit.

13. The electronic slide-in module according to claim 3, wherein the read-out unit comprises a plurality of contact elements that generate electrical information when they interact with counter contact elements of the information storage unit in the module carrier, and the contact elements are mechanically movable to close electrical contacts within the read-out unit.

14. The module carrier according to claim 6, wherein the information storage unit comprises an RFID transponder.

15. The module carrier according to claim 6, wherein the information storage unit comprises a plurality of recesses that interact with contact elements of the read-out unit of the slide-in module and have different depths such that information is coded mechanically.

16. The module carrier according to claim 7, wherein the information storage unit comprises a plurality of recesses that interact with contact elements of the read-out unit of the slide-in module and have different depths such that information is coded mechanically.

17. The module carrier according to claim 6, wherein the information storage unit is a passive unit without power supply.

18. The module carrier according to claim 7, wherein the information storage unit is a passive unit without power supply.

19. The module carrier according to claim 8, wherein the information storage unit is a passive unit without power supply.
